(19) United States
(12) Patent Application Publication
(10) Pub. No.: US 2010/0155510 A1
(43) Pub. Date: Jun. 24, 2010

(54) NOZZLE TRUMPET

(76) Inventor: Daniel W. Bamber, St. Clair Shores, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/341,519

(22) Filed: Dec. 22, 2008

(51) Int. Cl. B05B 1/00

(52) U.S. Cl. 239/601

(57) ABSTRACT

A nozzle extending along an axis is provided, including an orifice portion, an exit and a trumpet portion. The orifice portion includes an orifice dimension that is generally perpendicular to the axis. The exit allows for a fluid to exit the nozzle. The trumpet portion is located between the orifice portion and the exit, where an outer surface of the trumpet portion is angled outwardly towards the exit. The trumpet portion includes a trumpet angle. The trumpet angle is measured at the outer surface of the trumpet portion, where the trumpet angle is less than ninety degrees. A trumpet height is also included, where the trumpet height is measured at the trumpet portion, and the trumpet height is greater than the orifice dimension.

### TECHNICAL FIELD

The present disclosure relates to a nozzle, and in particular to a nozzle including a trumpet portion.

### BACKGROUND

Exhaust gas after treatment systems are commonly used in conjunction with diesel engines for reducing the amount of nitrous oxides (NOₓ) in an exhaust gas. One type of after treatment system includes an injector for spraying a reduction agent, such as ammonia, fuel or urea, into the exhaust gas. The exhaust gas is then transported to a catalytic converter, where the amount of nitrous oxides in the exhaust gas are reduced as the reduction agent reacts with the nitrous oxides in the exhaust gas to form water and nitrogen. After reacting in the catalytic converter, the exhaust gas is released from the catalytic converter to the atmosphere.

The injector typically includes an injector orifice, where the injector sprays the reduction agent out of the injection orifice. It may be beneficial in at least some after treatment systems to vary the pressure of the reduction agent at the injector orifice as the reduction agent is sprayed into an exhaust pipe. Spraying the reduction agent into the exhaust pipe at different pressures may result in a varied spray pattern. That is, the spray pattern of the injector changes depending on the pressure of the injector. More particularly, as the pressure in the injector orifice increases, the angular momentum of the reduction agent being sprayed out of the injector also increases. As a result of the increased angular momentum the reduction agent is sprayed at a higher angle into the exhaust pipe. Thus, varying the pressure at the injector orifice may result in a varied spray pattern of the reduction agent.

At least some exhaust pipes may be designed with the assumption that the injector will spray the reduction agent at a generally constant spray pattern, regardless of the pressure. Therefore, there exists a need for an injector that sprays the reduction agent from the injector orifice at varying pressures, while still maintaining a generally constant spray pattern.

### BRIEF DESCRIPTION OF THE DRAWINGS

FIG. 1 is a partial cross sectional view of an injector including a needle, a needle guide, a fluid and a nozzle;

FIG. 2 is an enlarged view of the nozzle in FIG. 1, including an orifice and a trumpet;

FIG. 3 is a partial cross sectional view of the nozzle where the fluid is exiting the nozzle;

FIG. 4 is a partial cross sectional view of the nozzle where the fluid is exiting the nozzle at a different supply pressure than the nozzle illustrated in FIG. 3; and

FIG. 5 is a process flow diagram of a method for atomizing a fluid.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

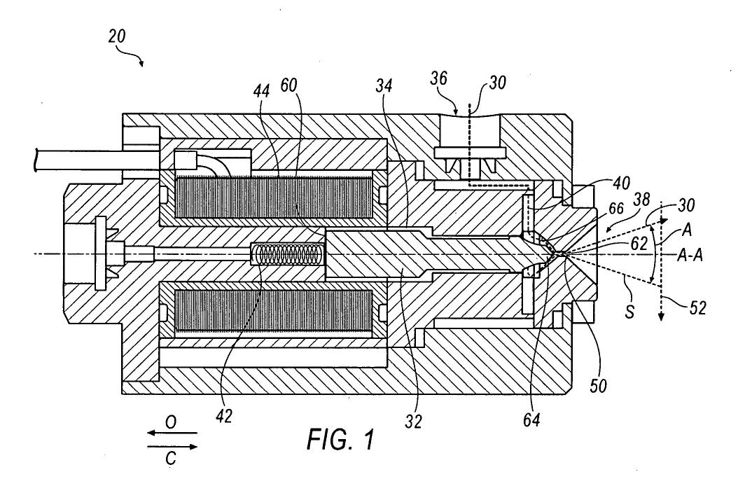

FIG. 1 illustrates an exemplary atomizer 20 for spraying a fluid 30. Although FIG. 1 illustrates the atomizer as an injector, any type of atomizing device, such as, but not limited to, a carburetor, airbrush, mister, or spray bottle may be used as well. The fluid 30 may exit the atomizer 20 in a spray, where the spray defines a spray pattern. The spray pattern may be a pattern of fluid droplets as the fluid 30 exits the atomizer 20. The fluid 30 may be supplied to the atomizer 20 with a supply pressure, where in at least some instances the supply pressure may vary. This is because it may be advantageous to vary the supply pressure to the atomizer 20. However, as the supply pressure is varied the spray pattern of the fluid 30 leaving the atomizer 20 varies as well. Varying the spray pattern of the fluid 30 may not be desired, as at least some applications may be designed with the assumption that the spray pattern remains generally constant. The atomizer 20 may be different from at least some other types of injectors, because the atomizer 20 may maintain a generally constant spray pattern, even as the supply pressure of the fluid 30 is changed.

In one example, the atomizer 20 may be a swirl type injector, and may include a needle 32, a needle guide 34, an atomizer inlet 36, an atomizer outlet 38, a swirl chamber 40, a biasing member 42, shown in the form of a spring, and a solenoid 44. The fluid 30 may be any fluid that can be atomized, and in one example the fluid 30 may be a fluid used in an exhaust gas after treatment system, such as, but not limited to, ammonia, fuel or urea. The atomizer outlet 38 includes a nozzle 50 extending along the axis A-A, where the fluid 30 may exit the atomizer 20 through the atomizer outlet 38 through the nozzle 50. The fluid 30 may then be sprayed into any predetermined location. FIG. 1 is an exemplary illustration of the atomizer 20 utilized in an exhaust gas after treatment system, where the fluid 30 exiting the atomizer 20 is sprayed into an exhaust gas stream 52.

FIG. 1 illustrates the atomizer 20 in an opened position. In the opened position, the fluid 30 enters into the atomizer 20 through the atomizer inlet 36, travels to the swirl chamber 40 and exits the atomizer 20 through the atomizer outlet 38. The needle 32 may be seated on a needle seat 60 within the needle guide 34. In the open position, the needle 32 may be retracted towards a first direction O which is in a direction generally opposite the atomizer outlet 38. The nozzle 50 includes an orifice 62, where the orifice 62 is unobstructed by a tip 64 of the needle 32 when the atomizer 20 is in the opened position. The atomizer 20 is in a closed position when the needle 32 is urged towards a second direction C, which is in a direction towards the atomizer outlet 38. In the closed position, the tip 64 of the needle 32 is seated along a needle seating surface 66, adjacent to the orifice 62. When in the closed position, the orifice 62 is at least partially blocked by the tip 64 of the needle 32 such that the fluid 30 may be at least partially restricted from exiting the nozzle 50.

As the fluid 30 exits the atomizer 20 through the atomizer outlet 38, a spray pattern S may be created. The spray pattern S may be defined as the pattern of fluid spray as the fluid 30 exits the injector. The spray pattern S includes a series of fluid droplets that may be created as the fluid 30 is atomized by the atomizer 20. The spray pattern S may include a spray angle A.

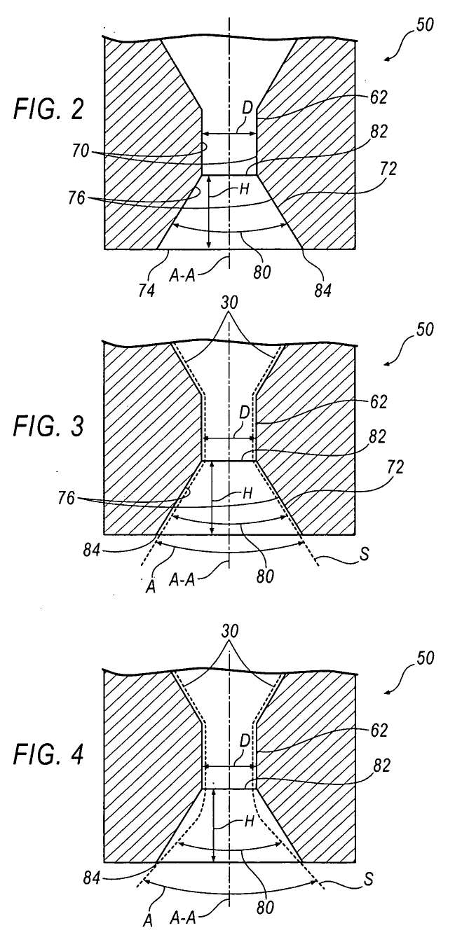

FIG. 2 is an enlarged view of the nozzle 50. The orifice 62 includes an orifice dimension D measured between outer surfaces 70 of the orifice 62. In one example, the orifice 62 may be generally cylindrical, and the orifice dimension D may be the diameter of the orifice 62. The orifice dimension D may be generally perpendicular to the axis A-A. The nozzle 50 also includes a trumpet portion 72 and an exit portion 74. The fluid 30 leaves the nozzle 50 through the exit portion 74, and the trumpet portion 72 may be located between the orifice 62 and the exit portion 74.

The geometry of the trumpet portion 72 may be generally funnel-shaped. In one example, the trumpet 72 includes a generally cone shaped profile, where outer surfaces 76 of the trumpet are angled outwardly towards the exit portion 74. The outer surfaces 76 of the trumpet 72 may define a trumpet angle 80, where the trumpet angle 80 identifies the positions where the outer surfaces 76 are angled in respect to one another. In the example as illustrated in each of FIGS. 1-4, the trumpet angle 80 is less than ninety degrees. In the illustrated example, the surfaces 76 are symmetrical about longitudinal axis A-A and including a generally constant angle. In other approaches, however, surfaces 76 may have a curvature with a changing angle while still maintaining their symmetry. In yet other approaches, the surfaces may not necessarily be symmetrical.

The nozzle 50 may also include an innerfirst edge 82 and an opposing outer second edge 84 longitudinally spaced from first edge 82. The first edge 82 may be located between the orifice 62 and the trumpet 72, and the second edge 84 may be located at the exit portion 74. The first edge 82 may be created as the outer surface 70 of the orifice 62 transitions to the outer surfaces 76 of the trumpet 72. The second edge 84 may be created as the trumpet 72 terminates at the exit portion 74. The first edge 82 and the second edge 84 may define a trumpet height H. More specifically, in one example, the trumpet height H may be defined as the distance between the first edge 82 and the second edge 84. The trumpet height H may be greater than the orifice dimension D.

The spray pattern S may depend at least in part by the geometry of both the orifice 62 and the trumpet 72. That is, maintaining the trumpet angle 80 at less than ninety degrees and allowing the trumpet height H to be greater than the orifice dimension D may create certain flow characteristics of the nozzle 50. More specifically, the trumpet 72 may be included with the nozzle 50 for maintaining a generally constant spray pattern S (illustrated in FIG. 1) as the supply pressure of the fluid 30 in the nozzle 50 changes, which is discussed in greater detail below.

FIGS. 3-4 illustrate the fluid 30 exiting the nozzle 50, where the supply pressure of the fluid 30 supplied to the orifice 62 in FIG. 3 is greater than the supply pressure of the fluid 30 supplied to the orifice 62 in FIG. 4. Although the supply pressures between the nozzles in FIGS. 3-4 are different, it should be noted that the spray patterns S are generally about the same. That is, the nozzle 50 may be different than at least some other atomizer nozzles, because the nozzle 50 may have the ability to maintain a generally constant spray pattern S as the supply pressure changes. In contrast, some other types of atomizer nozzles may include different spray patterns when the supply pressure changes. In one exemplary illustration, the supply pressure of the fluid 30 in FIG. 3 may be about 100 psi (689.5 kPa) and the supply pressure of the fluid 30 in FIG. 4 may be about 40 psi (275.8 kPa), however it should be noted that the geometry of the nozzle 50 may be adjusted for any range of supply pressures. It should also be noted that while FIGS. 3-4 illustrate only two different supply pressures, more than two supply pressures may be used with the nozzle 50 as well.

It may be advantageous to include a generally constant spray pattern S in at least some types of applications. For example, FIG. 1 illustrates the fluid 30 being sprayed into the exhaust gas stream 52 that may be located within an exhaust gas pipe (not shown). At least some exhaust gas pipes may be designed with the assumption that the spray pattern S remains generally constant. By utilizing the nozzle 50 with an exhaust gas pipe designed with the assumption of a generally constant spray pattern as the supply pressure of the fluid 30 is varied, it is possible to take advantage of some of the benefits that are provided by varying the supply pressure of the fluid 30. For example, it may be beneficial in at least some after treatment systems to vary the pressure of the fluid 30 at the exit portion 74 of the atomizer 20 as the fluid 30 sprays into the exhaust gas stream 52.

Turning back to FIG. 3, as the fluid 30 travels at a higher supply pressure than the fluid 30 as illustrated in FIG. 4, the fluid 30 is illustrated as generally contacting the outer surfaces 76 of the trumpet 72. The fluid 30 breaks contact with the nozzle 50 at the second edge 84 of the nozzle 50. By dimensioning the trumpet angle 80 to be less than ninety degrees, the flowrate of the fluid 30 may be decreased as the fluid 30 contacts the outer surfaces 76 of the trumpet 72.

In the examples as illustrated in FIGS. 1-4, the nozzle 50 is included with a swirl atomizer, which means that the fluid 30 may be spinning in a generally circular direction as the fluid 30 exits the nozzle 50. Because the supply pressure of the nozzle in FIG. 3 is greater than the supply pressure of the nozzle in FIG. 4, the velocity of the fluid 30 may be faster in FIG. 3 when compared to the fluid in FIG. 4. Therefore, if the trumpet 72 were omitted from the nozzle 50, the fluid 30 illustrated FIG. 3 would include a spray angle A greater than the fluid 30 as illustrated in FIG. 4, because a higher velocity translates to a greater spray angle A. In other words, the trumpet 72 may be included with the nozzle 50 for slowing the velocity of the fluid 30 at higher supply pressures.

Turning to FIG. 3, as the fluid 30 spins inside the trumpet 72 in a generally circular direction, a swirl pattern is created. The swirl pattern of the spinning fluid 30 includes a diameter, where the diameter of the swirl pattern increases as the fluid 30 advances inside the trumpet 72 towards the exit portion 74. This is because the angular momentum of the fluid 30 may be conserved as the fluid 30 loses velocity. Also, because the trumpet height H may be greater than the orifice dimension D, the fluid 30 has sufficient distance to travel such that the fluid 30 loses velocity. Thus, due to the angled outer surface 76 and the height H of the trumpet 72, as the fluid 30 exits the nozzle 50 enough velocity may be lost in order for the spray pattern S to be created by the fluid 30. That is, the trumpet 72 causes the fluid 30 to be sprayed at the spray angle A at higher supply pressures, which may be generally about the same as the spray angle A as illustrated in FIG. 4, at a lower supply pressure.

Therefore, including the trumpet 72 with the nozzle 50 with the trumpet angle 80 less than ninety degrees and the trumpet height H greater than the orifice dimension D may be advantageous for at least several reasons. First, if the trumpet 72 is eliminated, the angle A of the spray pattern S may increase. Moreover, if the trumpet angle 80 is greater than ninety degrees, the trumpet 72 will not contact the fluid 30 and the angle A of the spray pattern may increase. Additionally, if the trumpet height H is not greater than the orifice dimension D, then the fluid 30 may not have adequate distance to travel in order for the fluid 30 to decrease velocity. As a result, the fluid 30 may not decrease in velocity sufficiently in order to exit the nozzle 50 at the spray angle A.

FIG. 4 is an illustration of the fluid 30 traveling at a lower supply pressure than the fluid 30 as illustrated in FIG. 3, where the fluid 30 contacts the first edge 82 of the trumpet 72 before entering the trumpet 72. The fluid 30 then travels out of the nozzle 50 to create the spray pattern S and the spray angle A. Because the fluid breaks away from the nozzle 50 at the first edge 82 at a lower supply pressure, the fluid 30 exits the nozzle 50 creating the spray pattern S, similar to the spray pattern S as seen in FIG. 3. This is because both of the lower supply pressure fluid 30 as illustrated in FIG. 4 breaks from the first edge 82 and the higher supply pressure fluid 30 as illustrated in FIG. 3 breaks from the second edge 84 to produce nearly the same spray angle A.

By maintaining the trumpet height H to be greater than the orifice dimension D, and by maintaining the trumpet angle 80 to be less than ninety degrees, even as the supply pressure of the fluid 30 entering the orifice 62 increases, the spray pattern S and the spray angle A will remain generally about the same. Although only two different supply pressures are illustrated in each of FIGS. 3-4, it is understood that more than two different supply pressures may be used as well. In one illustrative example, the atomizer 20 may include a third supply pressure that is different from the first supply pressure and the second supply pressure. As the fluid 30 exits the atomizer 20 at the third supply pressure, the spray pattern S and the spray angle A may remain generally constant, similar to the spray pattern S as illustrated in each of FIGS. 3-4.

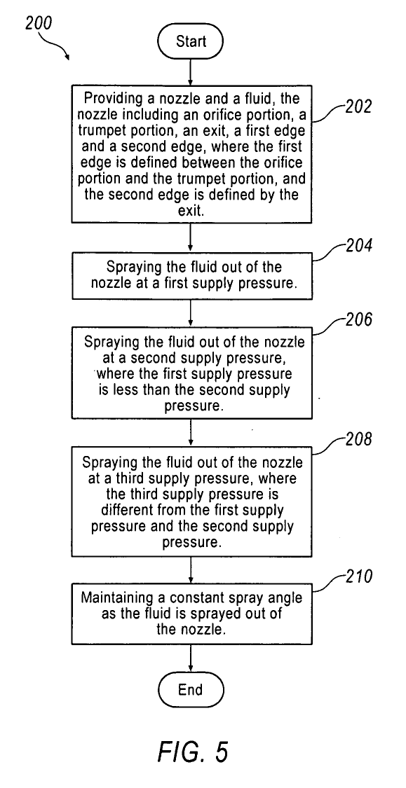

A method of atomizing the fluid 30 is also disclosed, and is illustrated generally in FIG. 5 as a process 200. Process 200 begins at step 202, where the nozzle 50 and the fluid 30 are provided. As discussed above, the nozzle 50 includes the orifice 62, the trumpet 72, the exit portion 74, the first edge 82 and the second edge 84. The first edge 82 may be defined between the orifice 62 and the trumpet 72. The second edge 84 may be defined at the exit portion 74. Process 200 may then proceed to step 204.

In step 204, the fluid 30 may be sprayed out of the nozzle 50 at the first supply pressure. As discussed above, the first supply pressure may be the pressure of the fluid 30 supplied to the orifice 62. When the fluid 30 is sprayed out of the nozzle 50 at the first supply pressure, the fluid 30 breaks contact with the nozzle 50 at the first edge 82, which is illustrated in FIG. 4. Process 200 may then proceed to step 206.

In step 206, the fluid 30 may be sprayed out of the nozzle 50 at the second supply pressure, where the first supply pressure may be less than the second supply pressure. When the fluid 30 is sprayed out of the nozzle 50 at the second supply pressure, the fluid breaks contact with the nozzle 50 at the second edge 84. In one example, the first supply pressure may be about 40 psi (275.8 kPa), and the second supply pressure may be about 100 psi (689.5 kPa). However, it should be noted that the geometry of the nozzle 50 may be adjusted for a range of acceptable supply pressures. Process 200 may then proceed to step 208.

In step 208, the fluid 30 may be sprayed out of the nozzle 50 at a third supply pressure. As discussed above, the third supply pressure may be different than the first supply pressure and the second supply pressure. When the fluid 30 is sprayed out of the nozzle 50 at the third supply pressure, the fluid 30 may break contact with the nozzle 50 at either of the first edge 82 or the second edge 84 or possibly between the edges along surface 76, which may depend on the value of the third supply pressure. More specifically, in one illustrative example if the third supply pressure may be greater than both of the first supply pressure and the second supply pressure, then the fluid 30 may break contact with the nozzle at the second edge 84. Alternatively, if the third supply pressure is less than both of the first supply pressure and the second supply pressure, then the fluid 30 may break contact with the nozzle at the first edge 82. Process 200 may then proceed to step 210.

In step 210, the spray angle S may be maintained as the fluid 30 is sprayed out of the nozzle 50. In other words, the spray angle S remains generally constant as the supply pressure of the fluid 30 varies. For example, the spray angle S may remain generally constant as the supply pressure varies between the first supply pressure, the second supply pressure and the third supply pressure. Process 200 may then terminate.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

What is claimed is:

1. A nozzle extending along an axis, comprising:
an orifice portion including an orifice dimension generally perpendicular to the axis;
an exit for allowing a fluid to exit the nozzle;
a trumpet portion located between the orifice portion and the exit, where an outer surface of the trumpet portion is angled outwardly towards the exit;
a trumpet angle that is measured at the outer surface of the trumpet portion, the trumpet angle being less than ninety degrees; and
a trumpet height that is measured at the trumpet portion generally parallel to the axis, where the trumpet height is greater than the orifice dimension.

2. The nozzle as recited in claim 1, where the nozzle is part of an atomizer.

3. The nozzle as recited in claim 2, where the atomizer is a swirl atomizer.

4. The nozzle as recited in claim 1, where the exit of the nozzle includes a spray angle, where the spray angle is defined by a spray pattern of the fluid exiting the nozzle.

5. The nozzle as recited in claim 4, further comprising at least two different supply pressures, where the two different supply pressures are the pressure of the fluid that is supplied to the orifice portion.

6. The nozzle as recited in claim 5, where the spray angle remains generally constant between the two different supply pressures.

7. The nozzle as recited in claim 5, where a first supply pressure is about 40 psi, and a second supply pressure is about 100 psi.

8. The nozzle as recited in claim 5, further comprising a first edge and a second edge, where the first edge is located between the orifice portion and the trumpet portion, and the second edge is located at the exit.

9. The nozzle as recited in claim 8, wherein the fluid breaks at the first edge at a first supply pressure, and the fluid breaks at the second edge at a second supply pressure, and the first supply pressure being less than the second supply pressure.

10. The nozzle as recited in claim 1, wherein the trumpet portion includes a geometry that is generally cone shaped.

11. An atomizer including a nozzle, comprising:
an orifice portion including an orifice diameter;
an exit for allowing a fluid to exit the nozzle;
a trumpet portion located between the orifice portion and the exit, where an outer surface of the trumpet portion is angled outwardly towards the exit;
a trumpet angle that is measured at the outer surface of the trumpet portion, the trumpet angle being less than ninety degrees; and
a trumpet height that is measured at the trumpet portion between an inner edge located between the orifice portion and the trumpet portion and an outer edge represented by the exit, where the trumpet height is greater than the orifice diameter.

12. The atomizer as recited in claim 11, wherein the trumpet is sized such that the fluid contacts at least a portion of the trumpet portion.

13. The atomizer as recited in claim 12, wherein the fluid contacts at least one of the inner edge and the outer edge.

14. The atomizer as recited in claim 11, where the atomizer is a swirl atomizer.

15. The atomizer as recited in claim 11, wherein the fluid breaks at the inner edge at a first supply pressure, and the fluid breaks at the outer edge at a second supply pressure, and the first supply pressure is less than the second supply pressure.

16. The atomizer as recited in claim 11, wherein the trumpet portion includes a geometry that is generally cone shaped.

17. A method of atomizing a fluid, comprising:
providing a nozzle and a fluid, where the nozzle includes an orifice portion, a trumpet portion, an exit, a first edge and a second edge, where the first edge is defined between the orifice portion and the trumpet portion, and the second edge is defined at the exit;
spraying the fluid out of the nozzle at a first supply pressure, where the first supply pressure is the pressure of the fluid that is supplied to the orifice, and where the fluid breaks contact with the nozzle at the first edge;
spraying the fluid out of the nozzle at a second supply pressure, where the first supply pressure is less than the second supply pressure, and where the fluid breaks contact with the nozzle at the second edge; and
maintaining a generally constant spray angle as the fluid is sprayed out of the nozzle, where the spray angle is defined by a spray pattern of the fluid exiting the nozzle.

18. The method as recited in claim 17, further comprising the step of spraying the fluid out of the nozzle at a third supply pressure, where the third supply pressure is different than the first supply pressure and the second supply pressure.

19. The method as recited in claim 18, further comprising the step of maintaining the generally constant spray angle as the fluid is sprayed out of the nozzle at the third supply pressure.

20. The method as recited in claim 17, wherein the first supply pressure is less than the second supply pressure.
